(19) United States
(12) Patent Application Publication
(10) Pub. No.: US 2026/0322662 A1
(43) Pub. Date: Oct. 15, 2026

(54) WIRELESS FRAME PROCESSING METHOD AND WIRELESS COMMUNICATION DEVICE

(71) Applicant: Realtek Semiconductor Corporation, Hsinchu (TW)

(72) Inventor: Fengxiang WANG, Jiangsu Province (CN)

(21) Appl. No.: 19/562,837

(22) Filed: Mar. 11, 2026

(30) Foreign Application Priority Data
Mar. 25, 2025 (CN) 202510353887.0

(51) Int. Cl. H04L 25/03; H04L 27/22

(52) U.S. Cl. CPC H04L 25/03949; H04L 27/22

(57) ABSTRACT

A wireless frame processing method includes: performing a first demodulation, a first equalization, a first data detection, and a first decoding on a physical layer header field of a frame to obtain first header with a first data rate; when the first header fails the check, performing a second demodulation, a second equalization, and a second data detection on some symbols in a payload field of the frame according to the first data rate, and performing a joint decoding on the physical layer header field and some symbols in the payload field, followed by a header decoding on a result of the second decoding to obtain second header; and when the second header passes the check, performing a third demodulation, a third equalization, a third data detection, and a payload decoding on the payload field based on a second data rate and a frame length in the second header.

### RELATED APPLICATIONS

This application claims priority to China Application Serial Number 202510353887.0, filed Mar. 25, 2025, which is herein incorporated by reference.

### BACKGROUND

### Technical Field

The present disclosure relates to processing of wireless frames, and more particularly to a wireless frame processing method and a wireless communication device with a joint decoding function.

### Description of Related Art

Convolutional coding technology improves communication reliability by adding redundant information, and is used in many communication network systems, such as a wireless personal area network (WPAN). Correspondingly, Viterbi decoding is typically applied to a receiving terminal, where the variation rule of the registers are utilized to construct a transition matrix and search for a globally optimal path according to soft information obtained after an equalization, thereby acquiring a coding gain. An ultra-wideband (UWB) system using the IEEE 802.15.4 series protocols also adopts the convolutional coding technology. In such protocols, when the constraint length of the convolutional code is 3, the header field and payload field are jointly encoded, and decoding the payload field depends on the content of the header field. In the conventional processing flow, the header field is decoded first to obtain the data rate and the frame length payload field, and then the payload field is processed. In such processing method, some segments in the header field may be incorrectly decoded due to insufficient traceback length. The decoding performance of the payload field is also affected if the header field cannot be decoded correctly.

### SUMMARY

The present disclosure provides a wireless frame processing method which includes: performing a first demodulation, a first equalization, a first data detection, and a first decoding on a PHR field of a wireless frame to obtain first header bit data with a first data rate and a first frame length; in response to the first header bit data failing a first check, performing a second demodulation, a second equalization, and a second data detection on first M symbols in a payload field of the wireless frame according to the first data rate, and performing a second decoding on the PHR field and the first M symbols, followed by a header decoding on a result of the second decoding to obtain a second header bit data, wherein M is a positive integer, and the second decoding is a joint decoding; and in response to the second header bit data passing a second check, performing a third demodulation, a third equalization, a third data detection, and a payload decoding on the payload field according to a second data rate and a second frame length in the second header bit data to obtain payload bit data.

The present disclosure further provides a wireless communication device which includes an RF circuit, a pulse shaper, a data detector, a data decoder, a header decoder, and a payload decoder. The pulse shaper is coupled to the RF circuit, the data detector is coupled to the pulse shaper, the data decoder is coupled to the data detector, the header decoder is coupled to the data decoder, and the payload decoder is coupled to the data decoder. The RF circuit, the pulse shaper, and the data detector are configured to sequentially perform a first demodulation, a first equalization, and a first data detection on first M symbols in a payload field of a wireless frame according to a data rate in a PHR field of the wireless frame, the data decoder is configured to perform a first decoding on the PHR field and the first M symbols, and the header decoder is configured to perform a header decoding on a result of a first decoding to obtain first header bit data, in which M is a positive integer, and the first decoding is a joint decoding. In response to the first header bit data passing a check, the RF circuit, the pulse shaper, the data detector, and the data decoder are configured to sequentially perform a second demodulation, a second equalization, a second data detection, and a second decoding on the payload filed, and the payload decoder is configured to perform a payload decoding on a result of the second decoding to obtain payload bit data.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 and FIG. 2 are schematic electrical block diagrams respective of a transmitting terminal and a receiving terminal of a wireless communication network in accordance with some embodiments of the present disclosure.

FIG. 3 is an example of a UWB frame.

FIG. 4 is an example of a convolutional encoder used by the data encoder of the transmitting terminal in FIG. 1.

FIG. 5 is an example of a symbol structure formed by burst position modulation (BPM).

FIG. 6 is a flowchart of a wireless frame processing method in accordance with some embodiments of the present disclosure.

### DETAILED DESCRIPTION

The detailed explanation of the disclosure is described as following. The described preferred embodiments are presented for purposes of illustrations and description, and they are not intended to limit the scope of the disclosure.

It will be understood that, although the terms such as “first,” “second,” and “third” may be used herein to describe various signals, information, and/or operations, these signals, information, and/or operations should not be limited by these terms. These terms are only used to distinguish a signal, information, and/or operation from another signal, information, and/or operation.

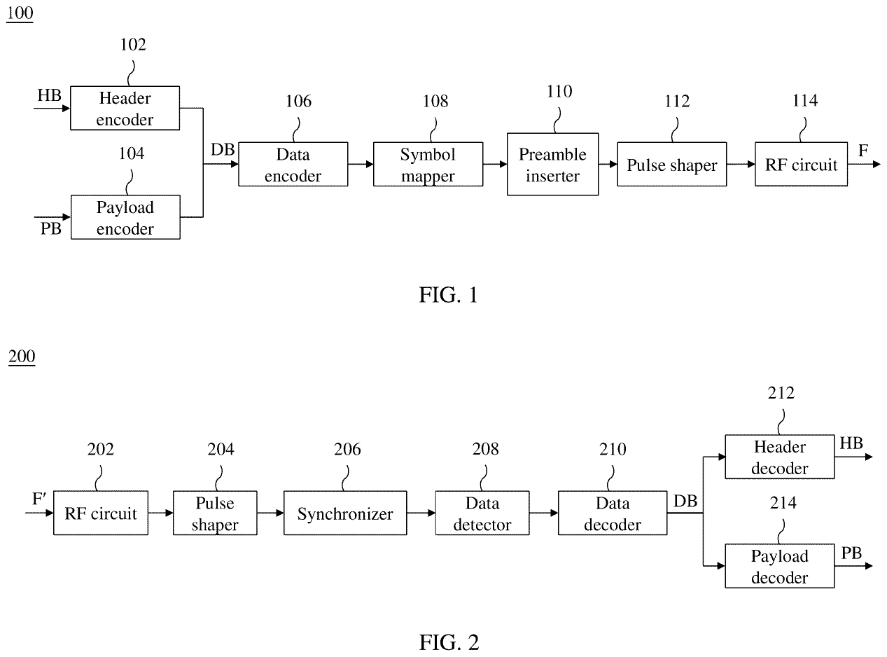

FIG. 1 and FIG. 2 are schematic electrical block diagrams respective of a transmitting terminal 100 and a receiving terminal 200 of a wireless communication network in accordance with some embodiments of the present disclosure, in which the wireless communication network may be a wireless personal area network (WPAN), such as IEEE 802.15.3 or IEEE 802.15.4, and the transmitting terminal 100 may transmit a wireless frame to the receiving terminal 200 through a channel in the wireless communication network. The transmitting terminal 100 and the receiving terminal 200 may be wireless communication devices that support technologies such as, but not limited to, UWB, Zigbee, and Thread. In some embodiments, the transmitting terminal 100 and the receiving terminal 200 may further have functions of receiving and transmitting a wireless frame, respectively.

As shown in FIG. 1, the transmitting terminal 100 includes a header encoder 102, a payload encoder 104, a data encoder 106, a symbol mapper 108, a preamble inserter 110, a pulse shaper 112, and a radio frequency (RF) circuit 114, in which the header encoder 102 and a payload encoder 104 are collectively coupled to the data encoder 106, and the data encoder 106, the symbol mapper 108, the preamble inserter 110, the pulse shaper 112, and the RF circuit 114 are sequentially coupled, the header encoder 102, a payload encoder 104, the data encoder 106, the symbol mapper 108, the preamble inserter 110, the pulse shaper 112, and the RF circuit 114 may be circuits that are integrated in one or more chips. The header encoder 102 and a payload encoder 104 respectively encode header bit data HB and payload bit data PB. The encoded header bit data HB and the encoded payload bit data PB are combined into bit data DB, and then the data encoder 106 performs a continuous encoding on the bit data DB. Afterwards, the symbol mapper 108, the preamble inserter 110, the pulse shaper 112, and the RF circuit 114 sequentially perform a symbol mapping, a preamble insertion, and a modulation on the encoded bit data DB to obtain a wireless frame F. The wireless frame F is emitted via the antenna (not shown) of the transmitting terminal 100, and is transmitted to the receiving terminal 200 through a wireless channel.

Corresponding to the transmitting terminal 100 in FIG. 1, as shown in FIG. 2, the receiving terminal 200 includes an RF circuit 202, a pulse shaper 204, a synchronizer 206, a data detector 208, a data decoder 210, a header decoder 212, and a payload decoder 214, in which the RF circuit 202, the pulse shaper 204, the synchronizer 206, the data detector 208, and the data decoder 210 are sequentially coupled, and the header decoder 212 and the payload decoder 214 are collectively coupled to the data decoder 210. Similarly, the RF circuit 202, the pulse shaper 204, the synchronizer 206, the data detector 208, the data decoder 210, the header decoder 212, and the payload decoder 214 may be circuits integrated into one or more chips. In the process of the receiving terminal 200, the antenna (not shown) receives a wireless frame F′ (formed by the effects of the wireless channel and the noise on the wireless frame F) first, and then the RF circuit 202, the pulse shaper 204, the synchronizer 206 and the data detector 208 sequentially perform a synchronization, a demodulation, an equalization, and a data detection on the wireless frame F′ to obtain a bit stream. Afterwards, the data decoder 210 decodes the bit stream to obtain the bit data DB, and the header decoder 212 and the payload decoder 214 decodes the bit data DB to respectively obtain the header bit data HB and the payload bit data PB from the bit data DB.

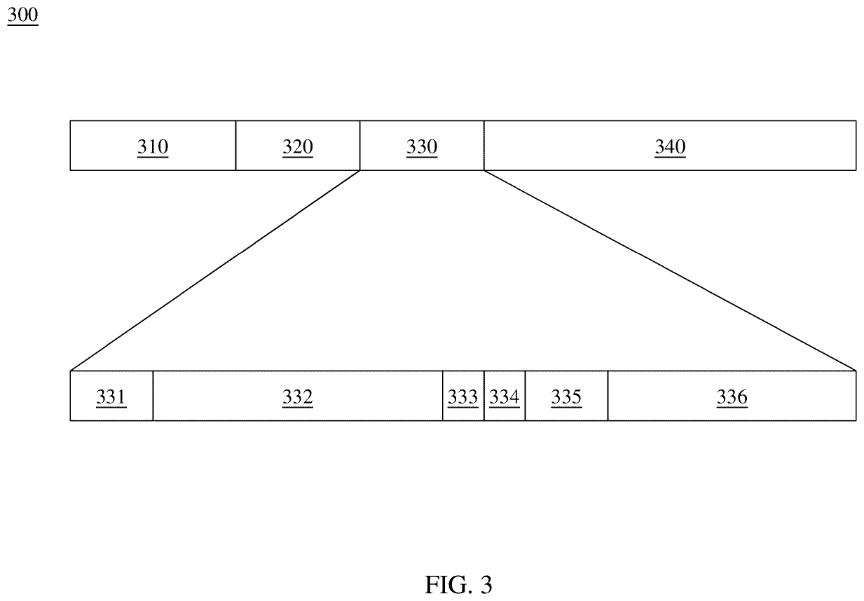

The wireless frame transmitted to the receiving terminal 200 by the transmitting terminal 100 may be a UWB frame, and the data decoder 210, the header decoder 212, and the payload decoder 214 may be a convolutional decoder (e.g., a Viterbi decoder), a single error correction, double error detection, (SECDED) decoder, and a Reed-Solomon decoder, respectively. FIG. 3 is an example of a UWB frame 300. The UWB frame 300 is one of the packet formats in the IEEE 802.15.4 standards, including a synchronization field 310, a start of frame delimiter (SFD) field 320, a physical layer header (PHR) field 330, and a payload field 340, in which the synchronization field 310 is used for synchronization of the transmitting terminal and the receiving terminal, the SFD field 320 is used for indicating the starting point of the frame, the PHR field 330 includes payload related information, and the payload field 340 is a physical service data unit (PSDU). Further, the data structure of the PHR field 330 includes a data rate 331, a frame length 332, a ranging packet 333, a header extension 334, a preamble duration 335, and SECDED check bits 336, in which the data rate 331 is the transmission rate of the payload, the frame length 332 is the length of the payload, the ranging packet 333 is used for measuring the distance between the transmitting terminal and the receiving terminal, the header extension 334 is reserved bits, the preamble duration 335 is the length of the synchronization field 310, and the SECDED check bits 336 are used for decoding check of the frame.

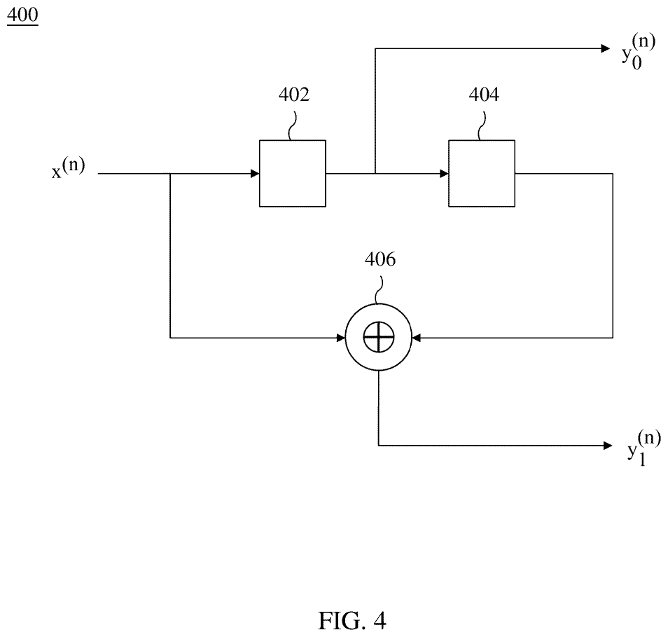

The data encoder 106 may use a convolutional encoder to perform a continuous encoder on the bit data DB. FIG. 4 is an example of a convolutional encoder 400 used in the data encoder 106. As shown in FIG. 4, the convolutional encoder 400 adopts systematic coding with the constraint length 3 and the coding rate 1/2, and includes registers 402, 404 and an adder 406, in which the input end of the register 402 receives input bits x⁽ⁿ⁾, the input end of the register 404 is coupled to the output end of the register 402, and the two input ends of the adder 406 are respectively coupled to the input end of the register 402 and the output end of the register 404. Each of the registers 402 and 404 is configured to provide a unit delay for the inputted bits, and the adder 406 is configured to perform a modulo-2 addition to obtain a parity bit. In the convolutional encoder 400, the outputs of the register 402 and the adder 406 are configured to respectively output systems bits

$${y}_{0}^{( n )}$$

and parity bits

$${y}_{1}^{( n )} ,$$

and the systematic bit

$${y}_{0}^{( n )}$$

and the parity bit

$${y}_{1}^{( n )}$$

outputted at the same time (i.e., the same n) constitutes a symbol. In addition, in certain embodiments, a convolutional encoding may not be performed on payload field 340.

Taking the UWB frame 300 in FIG. 3 as an example, the PHR field 330 includes 19 bits which are labeled by H₀, H₁, . . . , and H₁₈, respectively, and the subsequent payload field 340 includes N bits (N is a positive integer), which are labeled by D₀, D₁, . . . , and D_{(N-1)}, respectively. By using the convolutional encoder 400 to decode the UWB frame 300, the input bit x⁽ⁿ⁾, the systematic bit

$${y}_{0}^{( n )} ,$$

and the parity bit

$${y}_{1}^{( n )}$$

corresponding to the symbol with the sequence number of n are as shown in TABLE 1, in which T₀ and T₁ are tail bits, and ⊕ represents modulo-2 addition. In the embodiments of the present disclosure, the transmitting terminal performs a continuous encoding on the PHR field 330 and the payload field 340, and thus the registers 402, 404 at the tail of the PHR field 330 do not return to zero. The continuous encoding is the basis of the joint decoding that is able to be used.

TABLE 1

| Sequence number n | Input bit x⁽ⁿ⁾ | $System bit {y}_{0}^{( n )}$ | $Parity bit {y}_{1}^{( n )}$ |
|---|---|---|---|
| 0 | H₀ | 0 | H₀ |
| 1 | H₁ | H₀ | H₁ |
| 2 | H₂ | H₁ | H₀ ⊕ H₂ |
| 3 | H₃ | H₂ | H₁ ⊕ H₃ |
| . | . | . | . |
| . | . | . | . |
| . | . | . | . |
| 16 | H₁₆ | H₁₅ | H₁₄ ⊕ H₁₆ |
| 17 | H₁₇ | H₁₆ | H₁₅ ⊕ H₁₇ |
| 18 | H₁₈ | H₁₇ | H₁₆ ⊕ H₁₈ |
| 19 | D₀ | H₁₈ | H₁₇ ⊕ D₀ |
| 20 | D₁ | D₀ | H₁₈ ⊕ D₁ |
| 21 | D₂ | D₁ | D₀ ⊕ D₂ |
| . | . | . | . |
| . | . | . | . |
| . | . | . | . |
| N + 17 | D_{(N-2)} | D_{(N-3)} | D_{(N-4)} ⊕ D_{(N-2)} |
| N + 18 | D_{(N-1)} | D_{(N-2)} | D_{(N-2)} ⊕ D_{(N-1)} |
| N + 19 | T₀ | D_{(N-1)} | D_{(N-2)} ⊕ T₀ |
| N + 20 | T₁ | T₀ | D_{(N-1)} ⊕ T₁ |

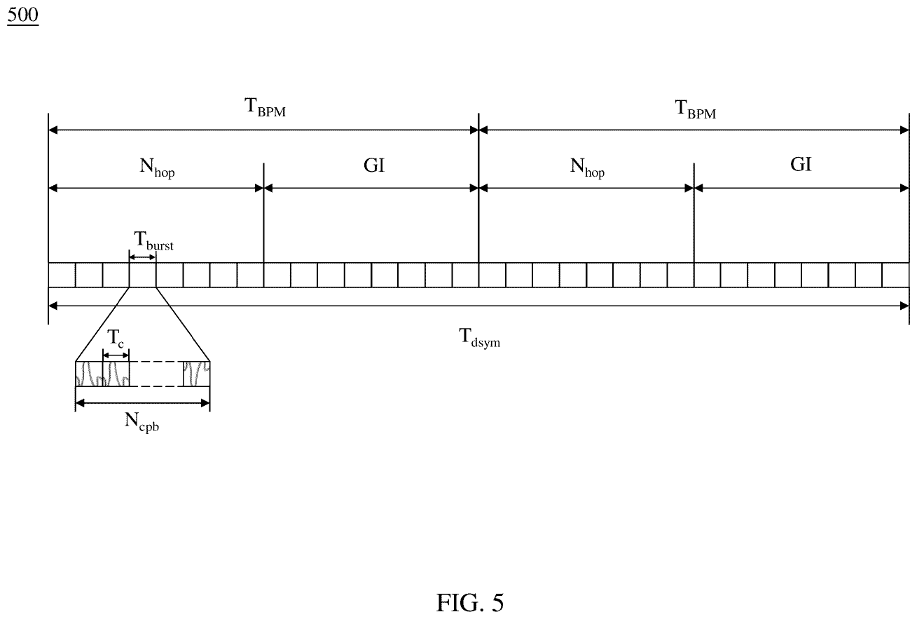

FIG. 5 is an example of a symbol structure 500 formed by burst position modulation (BPM). The symbol structure 500 correspond to a symbol of a wireless frame, in which the position of the data is determined by the scrambling code and the system bit of the symbol, and the pulse polarity of the data is determined by the scrambling code and the parity bit of the symbol. Specifically, as shown in FIG. 5, the symbol structure 500 has a time length per one symbol T_{dsym}, of which the first half and the second half each have Nₕₒₚ possible burst positions (the first half and the second half each have the time length of a half symbol T_{BPM}, i.e., a half of the time length per one symbol T_{dsym}, and Nₕₒₚ represents the number of possible burst positions) and a subsequent guard interval GI. The encoded system bit determines that the data are in the first half or the second half of the symbol structure 500, and the scrambling code determines that the data are in one of the Nₕₒₚ possible burst positions. In a possible burst position with data, the pulse polarity is determined by the scrambling code and the encoded parity bit, and the burst time length T_{burst} is determined by a mean pulse repetition frequency (PRF) and a data rate, where the mean PRF is the number of chips per each burst N_{cpb} divided by the time length per one symbol T_{dsym} (i.e., N_{cpb}/T_{dsym}). The pulse burst positions and the length in the payload field are all related to the data rate, and the data rate of the payload is recorded in the PHR field, and thus for the process in the receiving terminal, the data rate in the PHR field should be decoded first for the following processes of demodulation and equalization on the payload field.

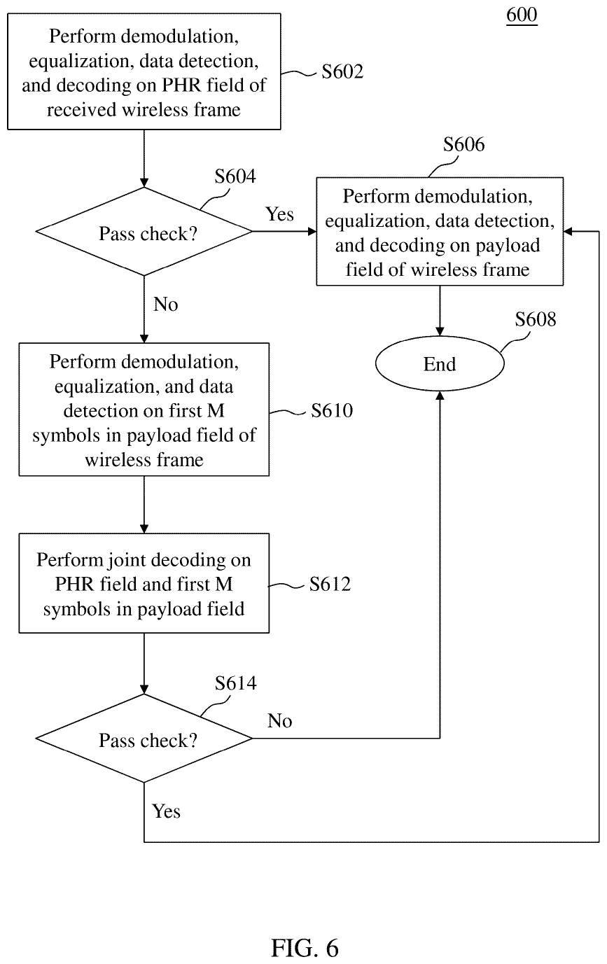

FIG. 6 is a flowchart of a wireless frame processing method 600 in accordance with some embodiments of the present disclosure. The wireless frame processing method 600 is applicable to a receiving terminal of a wireless communication network, such as the receiving terminal in FIG. 2. In addition, the wireless frame decoded by the wireless frame processing method 600 may be, for example, a UWB frame.

In the wireless frame processing method 600, at first, Operation S602 is performed to perform a demodulation, an equalization, a data detection, and a decoding on the PHR field of the received wireless frame. Specifically, at Operation S602, a demodulation, an equalization, and a data detection are sequentially performed on the PHR field of the wireless frame first to obtain log-likelihood ratio (LLR) data corresponding to the PHR field, and then a convolutional decoder (e.g., a Viterbi decoder) is used to perform a convolutional decoding on the LLR data corresponding to the PHR field, followed by a header decoding on the decoding result of the convolutional decoder to obtain header bit data (including a data rate and a frame length). The header decoder for performing the header decoding may be a decoder with error correction and checking functions, such as but not limited to a SECDED decoder.

Afterwards, Operation S604 is performed to determine whether the obtained header bit data pass a check. If the obtained header bit data pass the check, Operation S606 is performed to perform a demodulation, an equalization, a data detection, and a decoding on the payload field of the wireless frame according to the data rate and the frame length in the header bit data. Specifically, at Operation S606, a demodulation, an equalization, and a data detection are sequentially performed on the payload field of the wireless frame to obtain the LLR data corresponding to the payload field, and then a convolutional decoder (e.g., a Viterbi decoder) is used to perform a convolutional decoding on the LLR data corresponding to the payload field, and then a payload decoding (e.g., a Reed-Solomon decoding) is performed on the decoding result of the convolutional decoder to obtain payload bit data. After Operation S606 is done, Operation S608 is then performed to end the process on the wireless frame.

Oppositely, if the result of Operation S604 is that the obtained header bit data fail the check, Operation S610 is performed to perform a demodulation, an equalization, and a data detection (data analysis) on the first M symbols (M is a positive integer) in the payload field of the wireless frame according to the data rate in the header bit data, and then Operation S612 is performed to perform a joint decoding on the PHR field and the first M symbols in the payload field and then perform a header decoding on the result of the joint decoding to re-obtain the header bit data (including the data rate and the frame length). In particular, Operation S610 is to sequentially perform a demodulation, an equalization, and a data detection (data analysis) on the first M symbols in the payload field of the wireless frame to obtain the LLR data corresponding to the first M symbols in the payload field, while Operation S612 is to combine the LLR data corresponding to the PHR field and the LLR data corresponding to the first M symbols in the payload field and to use a convolutional decoder (e.g., a Viterbi decoder) to perform a continuous convolutional decoding on the combined LLR data and a header decoding (which may be performed by a decoder with error correction and checking functions, e.g., a SECDED decoder) on the decoding result of the convolutional decoder to re-obtain the header bit data.

After Operation S612 is done, Operation S614 is then proceeded to determine whether the check is passed. If the check is passed, Operation S606 is performed; otherwise (representing that the header decoding fails), Operation S608 is performed.

It is noted that the wireless frame processing method 600 described above includes an independent decoding part (Operation S602) and a joint decoding part (Operations S610 and S612), in which the independent decoding part is to process only the PHR field of the wireless frame, while the joint decoding part is to process the PHR field and the first several bits in the payload field of the wireless frame, which is performed only when the independent decoding part does not pass the check, so as to avoid a negative gain. The joint decoding part is a new process of the present disclosure compared to the conventional process flow. In addition, the wireless frame processing method 600 may be implemented by hardware (e.g., the elements of the receiving terminal 200 in FIG. 2), or the decoding part may be implemented by firmware or software while the other part may be implemented by hardware.

According to the wireless frame processing method 600, if the independent decoding of the PHR field is not successful (the check is not passed), a further iteration may be performed, and a convolutional decoding can be jointly performed on the LLR data respectively corresponding to the PHR field and certain symbols in the payload field, so as to overcome the problem of decoding failure of a part of bits in the PHR field due to insufficient traceback depth. It is noted that in the independent decoding stage, if the data rate is incorrectly decoded, the LLR data corresponding to the payload field calculated according to the data rate is also unreliable, and at this point performing the joint decoding with one iteration does not improve the Viterbi decoding result of the PHR field. Fortunately, for the UWB frame, the data rate occupies the first 2 bits of the PHR field, and the traceback depth of the data rate bits is deeper relative to the subsequent data. Therefore, in the independent decoding stage, the decoding of the data rate is usually successful, but the subsequent data is possibly decoded in failure due to insufficient traceback depth. The joint decoding can be expected to improve the decoding accuracy of the PHR field, and such expectation can be confirmed by simulations. In protocol design, it is likely due to such consideration that the data rate is placed at the forefront.

The number of symbols in the payload field (i.e., M) used for the joint decoding may be 5 to 10 times of the number of tail bits corresponding to the wireless frame (corresponding to the number of registers in the encoder, i.e., the constraint length of the encoder minus 1; for instance, the constraint length is 3, and the number of tail bits is 2) for improving the decoding efficiency without excessively increasing the computational amount. For example, if the convolutional encoder 400 in FIG. 4 is adopted for encoding the UWB frame 300, the PHR field 330 and the first 10 bits (M=10) in the payload field 340 of the UWB frame 300 may be combined first, and then the joint decoding is performed. As can be seen from simulations, in a use case in which the mean pulse repetition frequency is 3.9 MHz, the PHR rate is 850 kbps, and the payload rate is 850 kbps, in comparison with the method of only adopting the independent decoding, the method of using the joint decoding can decrease signal-to-noise ratio (SNR) required for the packet error rate (PER) of the PHR field 330 to be 1% by 0.4 dB; in a use case in which the mean pulse repetition frequency is 62.4 MHz, the PHR rate is 6.8 Mbps, and the payload rate is 6.8 Mbps, in comparison with the method of only adopting the independent decoding, the method of using the joint decoding can decrease signal-to-noise ratio (SNR) required for the packet error rate (PER) of the PHR field 330 to be 1% by 0.8 dB.

In summary, in the embodiments of the present disclosure, the joint decoding is performed on the PHR field and a part of the payload field in a received wireless frame through iterative processes, so as to avoid erroneous decoding of the bits of the PHR field due to insufficient traceback depth. Therefore, in a scenario in which decoding of the payload field relies on the contents in the header field and the header and payload fields are continuously encoded, the embodiments of the present disclosure can improve the PER performance of the PHR field, and correspondingly improves the PER performance of the payload field.

Summarizing the above descriptions, the present disclosure provides a wireless frame processing method which includes: performing a first demodulation, a first equalization, a first data detection, and a first decoding on a PHR field of a wireless frame to obtain first header bit data with a first data rate and a first frame length; in response to the first header bit data failing a first check, performing a second demodulation, a second equalization, and a second data detection on first M symbols in a payload field of the wireless frame according to the first data rate, and performing a second decoding on the PHR field and the first M symbols, followed by a header decoding on a result of the second decoding to obtain a second header bit data, wherein M is a positive integer, and the second decoding is a joint decoding; and in response to the second header bit data passing a second check, performing a third demodulation, a third equalization, a third data detection, and a payload decoding on the payload field according to a second data rate and a second frame length in the second header bit data to obtain payload bit data. In one embodiment, performing the first decoding on the PHR field includes performing a convolutional decoding on the PHR field, and performing the joint decoding on the PHR field and the first M symbols includes performing a continuous convolutional decoding on the PHR field and the first M symbols. In one embodiment, the convolutional decoding on the PHR field and the continuous convolutional decoding on the PHR field and the first M symbols are performed by a Viterbi decoder. In one embodiment, the header decoding is performed by a SECDED decoder. In one embodiment, the payload decoding is performed by a Reed-Solomon decoder. In one embodiment, the wireless frame is a UWB frame. In one embodiment, the joint decoding on the PHR field and the first M symbols in the payload field to obtain the second header bit data is performed by a SECDED decoder. In one embodiment, the wireless frame processing method further includes: in response to the first header bit data passing the first check, performing the third demodulation, the third equalization, the third data detection, and the payload decoding on the payload field according to the first data rate and the first frame length to obtain the payload bit data. In one embodiment, M is 5 to 10 times of a number of tail bits corresponding to the wireless frame.

Summarizing the above descriptions, the present disclosure further provides a wireless communication device which includes an RF circuit, a pulse shaper, a data detector, a data decoder, a header decoder, and a payload decoder. The pulse shaper is coupled to the RF circuit, the data detector is coupled to the pulse shaper, the data decoder is coupled to the data detector, the header decoder is coupled to the data decoder, and the payload decoder is coupled to the data decoder. The RF circuit, the pulse shaper, and the data detector are configured to sequentially perform a first demodulation, a first equalization, and a first data detection on first M symbols in a payload field of a wireless frame according to a data rate in a PHR field of the wireless frame, the data decoder is configured to perform a first decoding on the PHR field and the first M symbols, and the header decoder is configured to perform a header decoding on a result of a first decoding to obtain first header bit data, in which M is a positive integer, and the first decoding is a joint decoding. In response to the first header bit data passing a check, the RF circuit, the pulse shaper, the data detector, and the data decoder are configured to sequentially perform a second demodulation, a second equalization, a second data detection, and a second decoding on the payload filed, and the payload decoder is configured to perform a payload decoding on a result of the second decoding to obtain payload bit data. In one embodiment, the data decoder is a convolutional decoder. In one embodiment, the convolutional decoder is a Viterbi decoder. In one embodiment, the header decoder is a SECDED decoder. In one embodiment, the payload decoder is a Reed-Solomon decoder. In one embodiment, the wireless frame is a UWB frame. In one embodiment, the RF circuit, the pulse shaper, the data detector, and the data decoder are further configured to sequentially perform a third demodulation, a third equalization, a third data detection, and a third decoding on the PHR field to obtain second bit data before sequentially performing the first demodulation, the first equalization, the first data detection, and the first decoding, and in response to the second bit data failing a second check, the RF circuit, the pulse shaper, the data detector, and the data decoder are configured to sequentially perform the first demodulation, the first equalization, the first data detection, and the first decoding. In one embodiment, M is 5 to 10 times of a number of tail bits corresponding to the wireless frame.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless frame processing method, comprising:
performing a first demodulation, a first equalization, a first data detection, and a first decoding on a physical layer header (PHR) field of a wireless frame to obtain first header bit data with a first data rate and a first frame length;
in response to the first header bit data failing a first check, performing a second demodulation, a second equalization, and a second data detection on first M symbols in a payload field of the wireless frame according to the first data rate, and performing a second decoding on the PHR field and the first M symbols, followed by a header decoding on a result of the second decoding to obtain second header bit data, wherein M is a positive integer, and the second decoding is a joint decoding; and
in response to the second header bit data passing a second check, performing a third demodulation, a third equalization, a third data detection, and a payload decoding on the payload field according to a second data rate and a second frame length in the second header bit data to obtain payload bit data.

2. The wireless frame processing method of claim 1, wherein performing the first decoding on the PHR field includes performing a convolutional decoding on the PHR field, and wherein performing the joint decoding on the PHR field and the first M symbols includes performing a continuous convolutional decoding on the PHR field and the first M symbols.

3. The wireless frame processing method of claim 2, wherein the convolutional decoding on the PHR field and the continuous convolutional decoding on the PHR field and the first M symbols are performed by a Viterbi decoder.

4. The wireless frame processing method of claim 1, wherein the header decoding is performed by a single error correction, double error detection (SECDED) decoder.

5. The wireless frame processing method of claim 1, wherein the payload decoding is performed by a Reed-Solomon decoder.

6. The wireless frame processing method of claim 1, wherein the wireless frame is an ultra-wideband (UWB) frame.

7. The wireless frame processing method of claim 1, further comprising:
in response to the first header bit data passing the first check, performing the third demodulation, the third equalization, the third data detection, and the payload decoding on the payload field according to the first data rate and the first frame length to obtain the payload bit data.

8. The wireless frame processing method of claim 1, wherein M is 5 to 10 times of a number of tail bits corresponding to the wireless frame.

9. A wireless communication device, comprising:
a radio frequency (RF) circuit;
a pulse shaper coupled to the RF circuit;
a data detector coupled to the pulse shaper;
a data decoder coupled to the data detector;
a header decoder coupled to the data decoder; and
a payload decoder coupled to the data decoder;
wherein:
the RF circuit, the pulse shaper, and the data detector are configured to sequentially perform a first demodulation, a first equalization, and a first data detection on first M symbols in a payload field of a wireless frame according to a data rate in a PHR field of the wireless frame, the data decoder is configured to perform a first decoding on the PHR field and the first M symbols, and the header decoder is configured to perform a header decoding on a result of a first decoding to obtain first header bit data, wherein M is a positive integer, and the first decoding is a joint decoding;
in response to the first header bit data passing a first check, the RF circuit, the pulse shaper, the data detector, and the data decoder are configured to sequentially perform a second demodulation, a second equalization, a second data detection, and a second decoding on the payload filed, and the payload decoder is configured to perform a payload decoding on a result of the second decoding to obtain payload bit data.

10. The wireless communication device of claim 9, wherein the data decoder is a convolutional decoder.

11. The wireless communication device of claim 10, wherein the convolutional decoder is a Viterbi decoder.

12. The wireless communication device of claim 9, wherein the header decoder is a SECDED decoder.

13. The wireless communication device of claim 9, wherein the payload decoder is a Reed-Solomon decoder.

14. The wireless communication device of claim 9, wherein the wireless frame is a UWB frame.

15. The wireless communication device of claim 9, wherein the RF circuit, the pulse shaper, the data detector, and the data decoder are further configured to sequentially perform a third demodulation, a third equalization, a third data detection, and a third decoding on the PHR field to obtain second bit data before sequentially performing the first demodulation, the first equalization, the first data detection, and the first decoding, and
in response to the second bit data failing a second check, the RF circuit, the pulse shaper, the data detector, and the data decoder are configured to sequentially perform the first demodulation, the first equalization, the first data detection, and the first decoding.

16. The wireless communication device of claim 9, wherein M is 5 to 10 times of a number of tail bits corresponding to the wireless frame.
